(19) United States
(12) Patent Application Publication
(10) Pub. No.: US 2010/0040276 A1
(43) Pub. Date: Feb. 18, 2010

(54) METHOD AND APPARATUS FOR DETERMINING A CELL CONTOUR OF A CELL

(75) Inventors: Thorsten Zerfass, Bad Sobernheim (DE); Thomas Rehn, Magdeburg (DE); Thomas Wittenberg, Erlangen (DE)

Correspondence Address: SCHOPPE, ZIMMERMANN , STOCKELER & ZINKLER;C/O KEATING & BENNETT, LLP, 1800 Alexander Bell Drive, SUITE 200, Reston, VA, 20191, US

(73) Assignee: Fraunhofer-Gesellschaft zur Foerderung der angewan dten Forschung e.V., Munich (DE)

(21) Appl. No.: 12/532,456

(22) PCT Filed: Mar. 19, 2008
(86) PCT No.: PCT/EP08/02215

§ 371 Date: Oct. 27, 2009

(30) Foreign Application Priority Data
Mar. 23, 2007 (DE) 10 2007 013 971.5

(51) Int. Cl. G06K 9/00

(52) U.S. Cl. 382/133

(57) ABSTRACT

A method for determining a cell contour of a cell having a cell nucleus and a cytoplasm in an image of the cell includes determining nucleus candidate pixels belonging to the nucleus. Further, the method comprises determining a pixel within the area formed by the nucleus candidate pixels for obtaining a central nucleus candidate pixel, determining a first edge candidate pixel as a pixel on a predetermined path leading away from the central nucleus candidate pixel by determining a change from a first section to a second section of a color space, and finding edge candidate pixels leading away from the first edge candidate pixel forming a boundary surrounding the cell, via a path-finding algorithm tending to prefer smaller path lengths and paths through pixels in the second section of the color space.

The present invention relates to a method and an apparatus for determining a cell contour of a cell and particularly to boundary-accurate segmentation of plasm and nuclei in leucocytes.

### BACKGROUND OF THE INVENTION

Secure determination and exact segmentation of white blood cells (leucocytes) in colored smears of peripheral blood is the basis for automatic image-based generation of a so-called differential blood count in the context of medical laboratory diagnostics (so-called computer-aided microscopy—CAM). The variety of white blood cells occurring in a blood smear in connection with their respective characteristic color distribution and texturation increases the difficulty of classification within the setting of complete automatization. While the automatic detection and segmentation of white blood cells in digital images is nowadays known, subsequent boundary-accurate segmentation of cell nucleus and, in particular, the cytoplasm with regard to subsequent classification has not yet been solved. Digital images can exist in different color schemes or color spectrums. An RGB color space specifies the color of an image point by its proportions of the three primary colors (red, green, blue), wherein an HSV color space specifies the color of an image point by an H value (hue), an S value (saturation) and a V value (value or luminosity).

Known approaches for segmentation of cytoplasm and cell nucleus of white blood cells often fall back on thresholding methods. This is described, for example, in Cseke, I.: “A fast segmentation scheme for white blood cell images” in 11^{th} I-APR Int. Conf. On Pattern Recognition Vol. III: Image, Speech & Signal Analysis. (1992) 530-533 and in Liao, Q., Deng, Y.: “An accurate segmentation method for white blood cell images” in: IEEE Intl. Sym. on Biomedical Imaging. (2002) 245-248. A method suggested by “Leucocyte segmentation and classification in blood-smear images” by Ramoser, H., Laurain, V., Bischof, H., et al in IEEE Engineering Medicine and Biology Society (2005) 3371-3374 additionally introduces probability-theoretical elements for differentiating between background, red blood cells as well as nucleus and plasm of the leucocytes. An active contour method for cell contour determination is used in “An automated differential blood count system” by Ongun, G., Halici, U., Leblebicioglu, K., et al in IEEE Eng. Med. and Biology Soc. 3 (2001) 2583-2586. The approach introduced in “A novel white blood cell segmentation scheme based on feature space clustering” by Jiang, K., Liao, Q. M., Xiong, Y. in Soft Comput. 10 (2006) 12-19 uses scale-space filtering for determining the cell nucleus and 3D watershed clustering of the image transformed to the HSV model. Additionally, in the preprint “Analysis of Blood and Bone Marrow Smears using Digital Image Processing Techniques” by H. Hengen, S. Spoor and M. Pandit, a method for disintegrating clusters of white blood cells was developed. In the preprint “Bildverarbeitung für ein motorisiertes Lichtmikroskop zur automatischen Lymphozytenidentifikation” by M. Beller, R. Stotzka, H. Gemmeke, K. F. Weibezahn and G. Knetlitschek, a motorized light microscope is used together with a CCD camera to further develop a detection system that can be used for lymphocytes. In the preprint “Automation of Differential Blood count” by N. Sinha and A. G. Ramakrishnan, a technique for counting white blood cells is developed, which uses the so-called K-means-clustering and EM-algorithm in particular. In the preprint “Blood Cell Segmentation using EM-algorithm” by the same authors, a method for the segmentation of blood cells is introduced, which uses the HSV color space and an expectation value maximization (EN) in particular. In the preprint “Statistical Evaluation of Computer extracted Blood Cell Features for Screening Populations to detect Leukemias” by H. M. Aus, H. Harms, V. ter Meulen and U. Gunzer (in NATO ASI Series Vol. F 30), a method for the segmentation of cell images is used, which combines color differences, equidistant isograms, and geometrical operations with a cell model. In the preprint “Microscopic Image Analysis using mathematical morphology: Application to haematological Cytology” by J. Angulo and G. Flandrin, a method for image analysis is introduced where mathematical morphology is used for pattern detection.

### SUMMARY

According to an embodiment, a method for determining a cell contour of a cell having cell nucleus and cytoplasm in an image of the cell may have the steps of: determining nucleus candidate pixels belonging to the cell nucleus; determining a pixel inside the area formed by the nucleus candidate pixels for obtaining a central nucleus candidate pixel; determining a first edge candidate pixel as a pixel on a predetermined path leading away from the central nucleus candidate pixel by detecting a change from a first section to a second section of a color space; and finding edge candidate pixels leading away from the first edge candidate pixel, forming a boundary surrounding the cell, via a path-finding algorithm tending to prefer smaller path lengths and paths through pixels in the second section of the color space.

According to another embodiment, an apparatus for determining a cell contour of a cell having a cell nucleus and a cytoplasm in an image of the cell may have: a means for determining nucleus candidate pixels belonging to the cell nucleus; a means for determining a pixel inside the area formed by the nucleus candidate pixels for obtaining a central nucleus candidate pixel; a means for determining a first edge candidate pixel as a pixel on a predetermined path leading away from the central nucleus candidate pixel by detecting a change from a first section to a second section of a color space; and a means for finding edge candidate pixels leading away from the first edge candidate pixel, forming a boundary surrounding the cell, via a path-finding algorithm tending to prefer smaller path lengths and paths through pixels in the second section of the color space.

Another embodiment may have a computer program having a program code for performing the inventive method when the computer program runs on a computer.

The present invention is based on the knowledge that the cell contour of a cell can be determined by a four-stage method. Therefore, first, image points or pixels, respectively, are determined that represent candidates for a cell nucleus, and, in a second step, a central nucleus candidate pixel is determined from this set of candidates. Starting from this central nucleus candidate pixel, a first edge candidate pixel is determined in a third step, by detecting color values of the image on a predetermined path leading away from the central nucleus candidate pixel, so that a change from a first section to a second section of the color space signalizes an edge of the cytoplasm. Finally, starting from this edge candidate pixel, a closed path is determined, preferably within the second section of the path space, so that the cytoplasm is mostly enclosed by the closed path. Thus, the last step includes finding continuous edge candidate pixels starting from the first edge candidate pixels that form a boundary surrounding the cell, via a path-finding algorithm tending to prefer smaller path lengths and paths through pixels in the second section of the color space.

An inventive apparatus comprises a means for determining nucleus candidate pixels, a means for determining a central nucleus candidate pixel, a means for determining a first edge candidate pixel as well as a means for finding continuous edge candidate pixels.

In particular, in embodiments of the present invention, a novel approach is followed, which combines the so-called level set/fast marching methods with a shortest path algorithm to thereby obtain a possibly complete and boundary-accurate segmentation of cell nucleus and cytoplasm. Starting materials are light microscope images of blood smears that have been treated by MGG-coloring (MGG=May-Grünwald-Giemsa). Thereby, certain components of the cell (cell nucleus, cytoplasm), background, red blood cells etc. are stained correspondingly and the respective colored characteristics are reflected in the selection of the parameterization of the following method. To be able to perform segmentation automatically, a three-stage algorithm, for example, can be used which can be roughly divided into:

1. image preprocessing;
2. finding nucleus and plasm; and
3. post-processing and fine correction.

Since some image elements, such as red blood cells (bluish edge due to coloring and optics) and granulocytes (texture with relative high-frequent color variance) are provided locally with atypical characteristics or characteristics interfering with the main algorithm, the images can be preprocessed first during preprocessing with an edge-maintaining and noise-suppressing Kuwahara filter. The Kuwahara filter is described, for example, in “On the evaluation of edge preserving smoothing filter” by Chen, S., Shih, T. Y. in: Proceedings of Geoinformatics. (2002) paper C43.

The second stage (finding nucleus and plasm) can be summarized as follows. For reducing the sensitivity against variations of the color components further, further processing takes place, for example, after transformation of the RGB input image to the HSV model. First, via a thresholding method, candidates are determined for the nucleus (dark blue coloring), which can be localized roughly in a relatively simple manner. The same serve first less for marking than for center determination of the cell. Within this set of candidates N arbitrarily n points S⊂N are selected, and the one fulfilling min_{xεS}Σ_{yεS}d(x, y), which means having the smallest distance d to all other points from S, is declared the provisional center m_{seed}. As a next step, determination of points just outside the cytoplasm or marking the latter is performed to be able to detect the contour of the cell. Here, a fast marching algorithm can be used, which is described, for example, in “Levelset methods and fast marching methods” Cambridge University Press (1999) by Sethian, J. A. and solves a discrete variation of the eikonal equation: ∥∇u(x)∥F(x)=1 in u, which simulates the propagation of a wave starting from m_{seed} in dependence on the color characteristic F underlying the pixels (wherein ∇ is the nabla operator and x indicates a point in the image level).

In the ideal case, the cell is already described by {u<F(m_{seed})+ε} with a suitable function F and ε. The reason that this is hardly ever the case in reality is mostly the blurred separation of the white and red cells; however, the result is mostly very suitable for inducing a complete separation with another method. The function F of the following structure has been found to be useful for the segmentation of leucocytes:

$$F ( x ) = \{ \begin{matrix}β & if \text{:} c ( x ) \geq {α}_{1} ( c ( x ) \geq {α}_{2} v ( x ) \leq γ ) \\ 0 & else\end{matrix} \qquad ( 1 )$$

wherein c(x) designates the sum of the three color components in the RGB space and ν(x) the value component in the HSV model in point x. The parameters are to be selected such that α₁ detects the image background, and α₂ or γ everything outside the background, c(x)<α₂ the cell nucleus and ν(x)>γ the cytoplasm. In order not to be dependent on a specific color situation, an iterative adaptation of the parameter γ can be implemented, α₁ and α₂ can remain unaltered for image series with the same capturing conditions. The value of γ, however, is iteratively increased, for example starting from a low level, until in one course in a north, south, west and east direction points P_{N}, P_{S}, P_{W}, P_{O}, are found from points close to m_{seed} from {u>F(m_{seed})+ε} which are to mark areas outside the cell according to the selection of the parameters. Subsequently, via a path-finding algorithm, a path along the contour of the cell can be determined. Thus, a Dijkstra variation causes the desired separation of the cell from its environment by using a color-dependent cost function c(x,y) for the (directional) edge between adjacent points x and y (neighborhood of eight) with

c(x,y)=∥x−y∥₂(1+α1_{{u<F(m}_{_{seed}}_{)+ε}}(y)+β∥m_{seed}−y∥₂+γ1_{H}_{_{blue}}(h(y)) (2)

wherein h(x) is the hue value in the HSV model in the point x and H_{blue} a subset of the blue hue value range, and 1_{A(x)} the indicator function of the set A. The parameters α and γ are, for example, selected such that the path does not run across the bluish-colored cell, while β leads the path not too far away from the cell.

Paths determined in such a manner that connect four points P_{N}, P_{S}, P_{W}, P_{O} by four sub-paths, often indicate the cell contour very clearly. While the above-described thresholding method for determining the cell nucleus is suitable for finding a good starting point m_{seed} within the cell to be segmented, it has proved to be unsuitable for detecting the full cell nucleus perceptible as such for the human eye. For this task, another thresholding method has been used which utilizes the ratio between the blue and green channel of the RGB input image.

Since it has turned out that, with the help of the above-described method, certain paths only hardly meet the concavities of the cytoplasm, post-processing of the path can improve the result. Thereby, the path can be shifted point-by-point in the direction m_{seed}, as long as the points are on the background that is clearly discernible by the color, or on the red blood cells. The pixel set obtained in this manner, which is connected and smoothed by edges, represents a result of the whole method regarding the cytoplasm.

The result regarding the cell nucleus can also be improved by a post-processing step. For example, parasitic isolated points can be removed via a morphological open-close filter.

The efficiency of the presented algorithm can be tested by a collection of samples including the most diverse types of leucocytes. Thereby, with the help of different parameters, the quality of the automatic segmentation can be compared to a segmentation previously performed by hand. In the evaluation, on the one hand, the Dice coefficient

$${C}_{D} ( A , B ) = \frac{2 \vert A ⋂ B \vert}{\vert A \vert + \vert B \vert} \qquad ( 3 )$$

can be used, as well as a normed Hausdorff metric

$$H ( A , B ) = \frac{{max}_{x ∈ A} {min}_{y ∈ B} ‖ x - y ‖ + {max}_{y ∈ B} {min}_{x ∈ A} ‖ x - y ‖}{2 max \{ diam A , diam B \}} . \qquad ( 4 )$$

The result can be summarized separately for cell nucleus and plasm as follows:

cytoplasm: C_{D}=0,94±0,02; H=0,91±0,03

and for the

cell nucleus: C_{D}=0,94±0,02; H=0,90±0,04.

The optical impressions of the segmentation results confirm the results of the evaluation by parameters.

An inventive method for the segmentation of leucocytes in nucleus and plasm, which is performed based on images in blood smears, can thus comprise, for example, a step of preprocessing by a Kuwahara filter and a subsequent fast marching method for determining the rough cell contour. Further, an inventive method can comprise a shortest path algorithm, which largely operates on the determined level sets for obtaining the cell area. Marking the cell nucleus can, for example, be substantially performed by pure thresholding operations. The results obtained thereby achieve good results both in an evaluation on a visual basis and via standard measures, such as Dice coefficients and Hausdorff distance.

Other features, elements, steps, characteristics and advantages of the present invention will become more apparent from the following detailed description of preferred embodiments of the present invention with reference to the attached drawings.

### BRIEF DESCRIPTION OF THE DRAWINGS

Embodiments of the present invention will be detailed subsequently referring to the appended drawings, in which:

FIG. 1 is a sequence of steps for determining a cell contour according to an embodiment of the present invention;

FIG. 2A is an extended sequence of steps for determining a cell contour with preprocessing and post-processing; FIG. 2b shows an area with an odd number of pixels formed around a given pixel;

FIG. 3 is a loop processing for determining a parameter γ;

FIG. 4 is an illustration of the algorithm including pre- and post-processing;

FIG. 5 is a graphical illustration of a cell contour with cell nucleus and cytoplasm;

FIG. 6 is a change of color values in the cell nucleus, cytoplasm and background;

FIG. 7 is an illustration for representing the shortest path algorithm,

FIGS. 8A to 8D are images for different stages of processing the algorithm; and

FIGS. 9A to 9D are images of four types of leucocytes and their processing in the inventive method.

### DETAILED DESCRIPTION OF THE INVENTION

Before the present invention is discussed in more detail below with reference to the drawings, it should be noted that the same elements in the figures are provided with the same or similar reference numerals and that a repeated description of these elements is omitted.

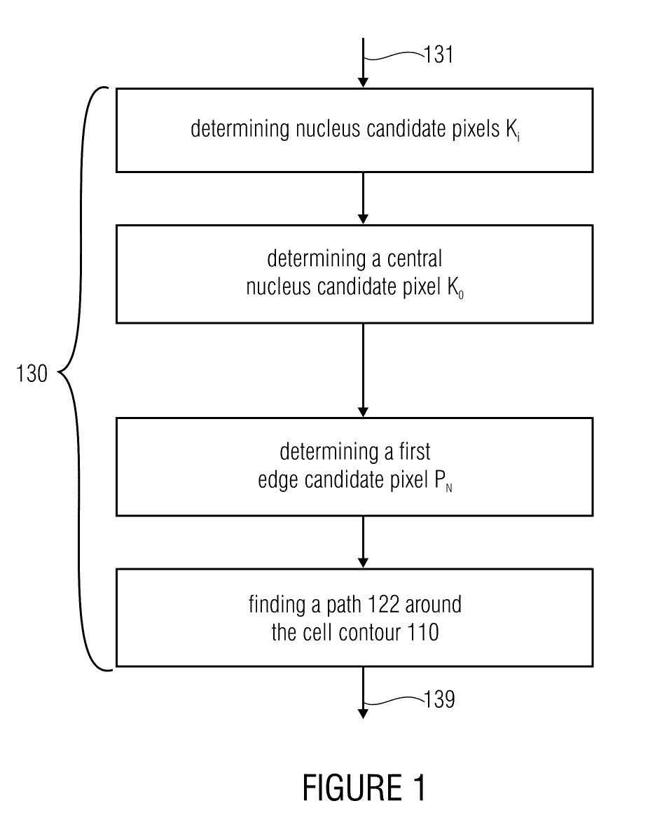

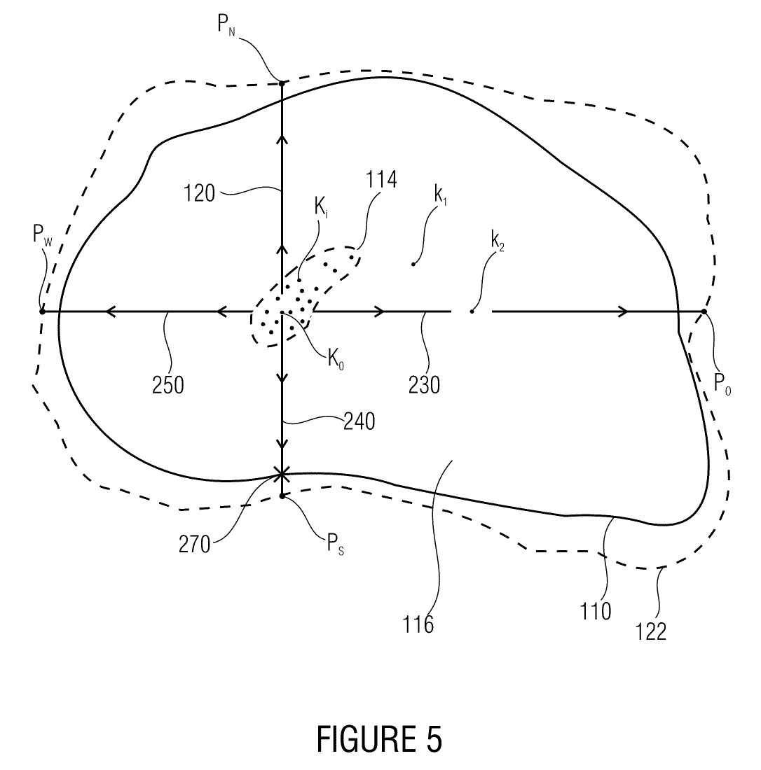

FIG. 1 shows a sequence of steps for determining a cell contour 110 of a cell having a cell nucleus 114 and a cytoplasm 116 in an image (see also bottom of FIG. 5) applied to an input 131.

First, nucleus candidate pixels Kᵢ, which are part of the cell nucleus 114, are determined and, in a subsequent step, a central nucleus candidate pixel K₀ is determined, wherein the central nucleus candidate pixel K₀ is inside an area formed by the nucleus candidate pixels Kᵢ. Subsequently, a first edge candidate pixel P_{N} is determined, wherein the first edge candidate pixel P_{N} is on a predetermined path 120 leading away from the central nucleus candidate pixel K₀ and is detected by a change from a first section to a second section of the color space. Depending on a color space used, the different sections are given by different color components and a change can be signaled, for example, in that one of these components of the used color space does not change continuously but erratically. After the determination of the first edge candidate pixel P_{N}, a path 122 is found, which substantially encloses the cell contour 110, for example by the fact that at least 90% of the path 122 are outside the cell contour 110. This finding can be performed by a path-finding algorithm, where, starting from the first edge candidate pixel P_{N}, edge candidate pixels leading away are found, which form a boundary surrounding the cell. Thereby, the path-finding algorithm can be executed such that both small path lengths and paths through pixels in the second section of the color space are preferred. This can be realized, for example, by a respectively selected cost function. The result of the execution of these method steps is then applied to an output 139.

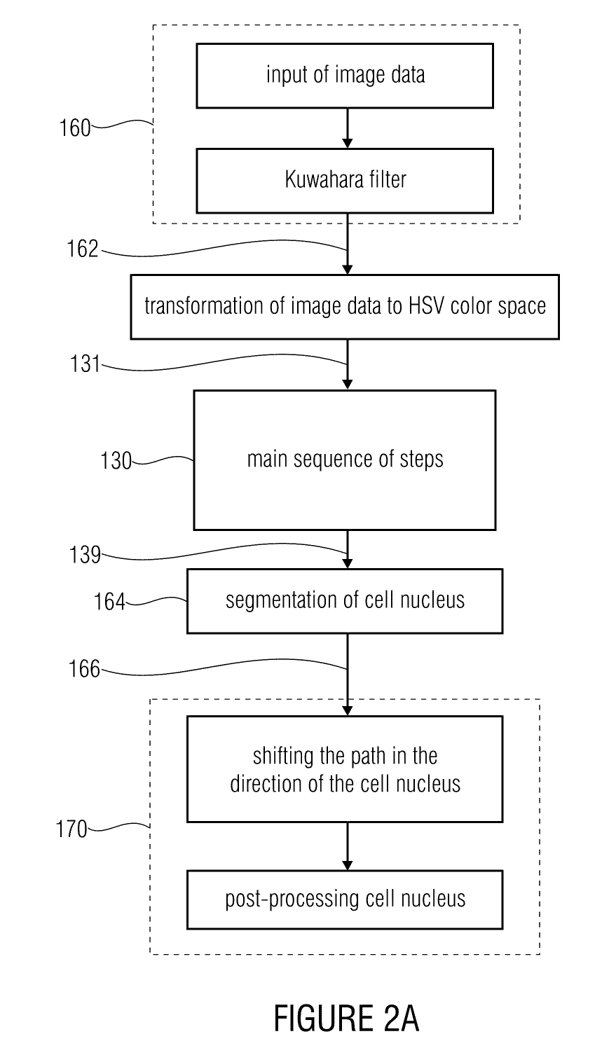

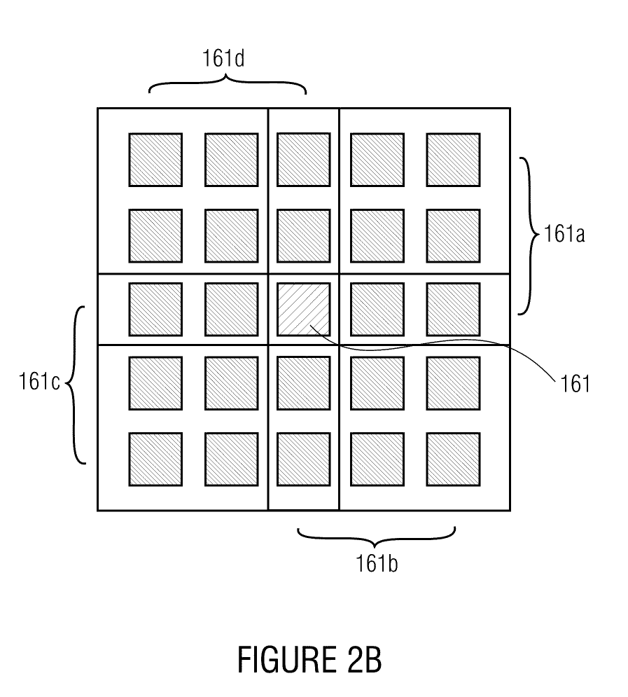

FIG. 2a shows an extended sequence of steps, wherein the sequence of steps shown in FIG. 1 is illustrated as the main sequence of steps 130, wherein the image data are applied at the input 131 and the output 139 provides the result of executing the main sequence of steps 130. According to the sequence of steps of FIG. 2a, first image data are input, e.g. in digital form in the RGB color scheme. These image data can then be preprocessed in a Kuwahara filter. A Kuwahara filter is a non-linear smoothing filter obtaining edges. As shown in FIG. 2b, an area with an odd number of pixels (5×5 in FIG. 2b) is formed around a given pixel 161, such that the given pixel 161 is in the center of the area. Then, four regions 161a, 161b, 161c, 161d are formed, such that the central pixel 161 represents a corner point of each of the four regions 161a, . . . , 161d. For each region, an average brightness is formed with a respective standard deviation. The Kuwahara filter now allocates the central pixel 161 to the average value of the region having the lowest standard deviation.

Thus, preparation 160 of the image data is terminated and the result is provided at an output 162 to a subsequent step where the image data can be transformed to a color space, which is used in the main sequence of steps 150. This can, for example, be the so-called HSV color space. Thereby, an H value characterizes the color type, such as, for example, red, blue or yellow, and is typically stated in a region or an angle of 0 to 360°. An S value indicates the saturation of the respective color type and is typically stated in a range from 0 to 100. In some applications, this saturation is also referred to as purity of the respective color, and the lower the saturation of a color, the more a gray hue can be detected and the more a fading of the color can be detected. A last value in the HSV color space is the V value indicating the brightness of a color and typically stated in percent (from 0 to 100%). Representing the HSV color space can be performed, for example, via a cone pyramid, wherein the angle variable corresponds to the H value, the radial direction to the S value and the height to the V value. There, the tip of the cone pyramid corresponds to the black color and the origin of the cone base area to the white color. In this image, every pixel can be represented by a pointer, wherein the pointer points to the point within or on the edge of the cone corresponding to the color.

In further embodiments, another color space can be used, but the HSV color space is favorable for the application of the segmentation of white blood cells. For example, the change in the transition from the cytoplasm 116 to a background or the transition from the cell nucleus 114 to the cytoplasm 116 can be particularly easily detected in the HSV color space. For example, a clear jump can easily be detected in one of the values of the color space by a computer program. In the HSV space, for example, a jump of the pointer can take place. After the image data have been transformed in the HSV color space, the sequence of the steps is executed, as shown in FIG. 1, and the result is applied to the output 139. In a subsequent step, segmentation 164 of the cell nucleus 114 can be performed, which means that the nucleus candidate pixels Kᵢ are merged to a cell nucleus 114 whose shape can vary according to different types. For the segmentation 164 of the cell nucleus 114, a thresholding method can be used, which is not based on the HSV color scheme, but where, in the RGB color space, a ratio between the blue and the green channel is examined. This means that pixels belonging to a cell nucleus 114 clearly differ in this ratio from other pixels.

The result of the segmentation 164 of the cell nucleus 114 is applied to the output 166, and the data are then subjected to post-processing 170. Post-processing 170 can thereby include, for example, shifting the path in the direction of the cell nucleus 114 (adapting the path to the cell contour), and in a last step post-processing the cell nucleus 114. Shifting the path in the direction of the cell nucleus 114 is useful, since finding the path in the path-finding algorithm has been executed such that points along the path that are outside the cytoplasm 116 were preferred, and thus the path 122 will rather be outside the cytoplasm 116 than inside the cytoplasm 116 (violation of the cell boundary or the cell contour 110 by the path 122 will only rarely occur). Shifting the path in the direction of the cell nucleus 114 can thereby be performed such that the path 122 is shifted in the direction of the cell nucleus 114 point-by-point, until the change from section 2 of the color space to section 1 of the color space becomes recognizable. Thus, the area enclosed by the path 122 is decreased until it mostly corresponds to the cell contour 110 of the cell. In the final post-processing of the cell nucleus 114, in particular candidate pixels kᵢ that are separated from the set of nucleus candidate pixels Kᵢ are eliminated, which can be clearly identified as cell nucleus 114 (e.g. isolated pixels kᵢ within the cytoplasm 116).

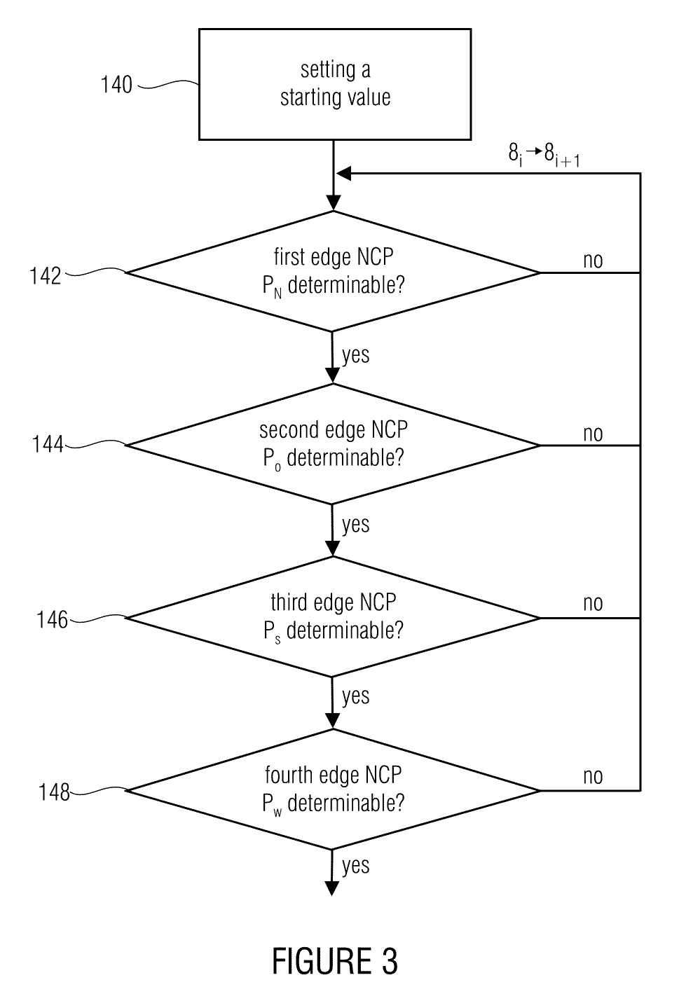

FIG. 3 shows a step cycle for determining a parameter γ parameterizing the cytoplasm 116. For example, in the HSV color model, the cytoplasm 116 can be characterized in that the V value, or the V component, in the HSV model exceeds a certain threshold, and this threshold corresponds to the value γ. Since this value can frequently not be selected universally, it is iteratively adapted to the respective conditions, and this adaptation can be performed by a step cycle as shown in FIG. 3. Since the edge of the cytoplasm 116 is signalized by falling below the V component in the HSV model below the boundary γ, an appropriate γ value can be determined by the fact that this falling below the boundary can be clearly signalized for several different paths. Thereby, first, in a step 140 a starting value γ₀ is selected, and subsequently, along a first path 120, a first edge candidate pixel P_{N} is determined by falling below the threshold V=γ₀. As long as this determination is not possible in the process step 142, feedback results, i.e. an increase of the starting value γ₀ to a latest value γ₁. By using the value γ₁, in the process step 142, a query is performed again whether the determination of a first edge candidate pixel P_{N} is possible. As long as it is again not possible, repetition of the process steps is performed, i.e. a further increase of the γ value until the first edge candidate pixel P_{N} can be determined. Subsequently, along a second path 230, an attempt is made to determine a second edge candidate pixel P_{O} by using the current value for γ. If this is not possible, the procedure will be started again from the beginning with a new increased value for γ. If the second edge candidate pixel P_{O} can also be determined, a third edge candidate pixel P_{S} will be determined in a third step along a third path 240. When this is possible with the current value for γ, a fourth edge candidate pixel P_{W} will be determined along a fourth path 250 in a fourth step 178. Only when all four edge candidate pixels P_{N}, P_{O}, P_{S}, P_{W} can be determined for a certain value for γ, the determined edge candidate pixels are used for determining a connection between first, second, third and fourth edge candidate pixels P_{N}, P_{O}, P_{S}, P_{W} in the path-finding algorithm.

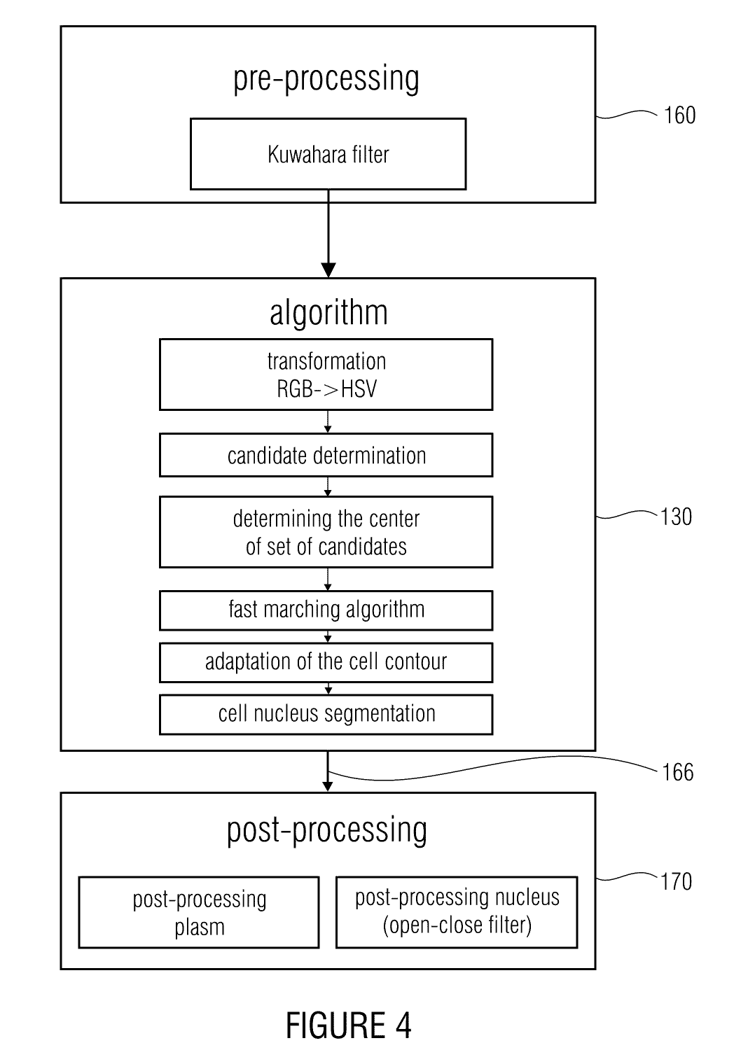

FIG. 4 shows an embodiment of the present invention, wherein the digital image is processed first in the RGB color scheme and the image data are processed in a preprocessing 160 via a Kuwahara filter. Then, the preprocessed images are transformed to the HSV color scheme, and candidate determination for nucleus candidate pixels Kᵢ belonging to the cell nucleus 114 is performed. Subsequently, the center K₀ of the set of candidates is determined, and then, in a fast marching algorithm, for example a first edge candidate pixel P_{N} can be determined. As described above, it is advantageous, when not only one edge candidate pixel but four edge candidate pixels P_{N}, P_{O}, P_{S}, P_{W} are determined along four different paths which are adapted to the cell contour 110 via a path-finding algorithm. Subsequently, segmentation of the cell nucleus 114 is performed, and the data determined in this manner are output at the output 166 and are further improved by post-processing 170. Post-processing 170 can, for example, comprise post-processing the cytoplasm 116, where the path 122 is shifted point-by-point in the direction of the cell nucleus 114 until the same reaches the edge of the cytoplasm 116, and in addition post-processing of the nucleus 114 can be performed with the aim of eliminating isolated points.

FIG. 5 shows a schematical illustration of the process sequence based on an example. A number of nucleus candidate pixels Kᵢ having an outer boundary 114 are shown. Starting from a central nucleus candidate pixel K₀, four paths are illustrated, a first path 120 to the point P_{N}, a second path 230 to the point P_{O}, a third path 240 to the point P_{S} and a fourth path 250 to the fourth edge candidate pixel P_{W}. By using the parameter γ, as shown in FIG. 3, crossing of the cell contour edge curve 110 can be determined along these four paths. This is the case, for example, for the third path 240, from the central nucleus candidate pixel K₀ to the third edge candidate pixel P_{S} when crossing the point 270. Analogously, the detection is also performed for the first path 120, for the second path 230 and for the fourth path 250. After the first edge candidate pixel P_{N}, the second edge candidate pixel P_{O}, the third edge candidate pixel P_{S} and the fourth edge candidate pixel P_{W} have been found, determination of the path 122 connecting all four edge candidate pixels P_{N}, P_{O}, P_{S}, P_{W} is performed in the path-finding algorithm. As has been described above, the path-finding algorithm is based on a procedure, such that the path 122 runs preferably outside the cell or the edge of the cytoplasm 116 illustrated by the cell contour 110. In the post-processing algorithm 170, among others, isolated nucleus candidate pixels k₁ and k₂ are eliminated, so that the nucleus is identified by the edge curve 114. However, it should be noted that within a cell different nucleuses separate from each other can occur. This, however, would imply that not only individual nucleus pixels k₁ or k₂ appear in the image, but that instead further “clouds” or areas of pixels would occur.

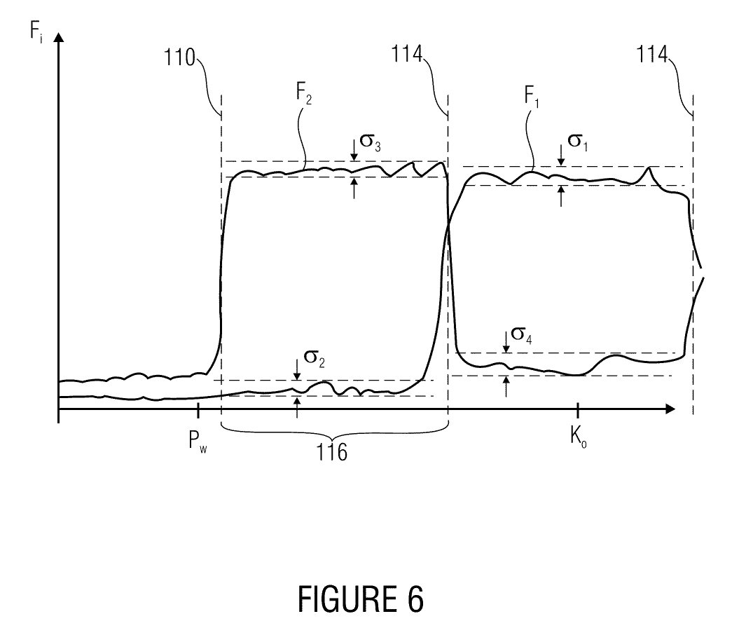

FIG. 6 shows a graphical illustration of how, by a transition from the cell nucleus 114 to the cytoplasm 116 or from the cytoplasm 116 to the background, certain components of the color space can change erratically. Here, the change of the color components along a direction is shown, leading, for example, from the central nucleus candidate pixel K₀ to the fourth edge candidate pixel P_{W}. The dotted line 114 represents the edge curve of the cell nucleus 114, and the dotted line 110 the edge curve of the cell contour (i.e. edge curve of the cytoplasm 116). Since the cell nucleus 114 has a specific color or color combination, a sudden change of the respective color components occurs at the boundary line 114, which is indicated by F₁ in this illustration. However, the color component F₁ shows certain fluctuations σ₁, σ₂ both inside the cell nucleus 114 (to the right of line 114) and outside the cell nucleus 114 (to the left of the dotted line 114), whose average values, however, differ significantly from each other, for example by more than 30%.

The cytoplasm 116 has another coloring than the cell nucleus 114, so that in the area of the cytoplasm 116, i.e. between the dotted line 114 and the dotted line 110, another color component, here designated by F₂, has a significantly excessive value. For the further color component F₂ as well, fluctuations σ₃, σ₄ can occur both inside the cytoplasm 116 and outside the cytoplasm 116, whereby, however, average values for F₂ differ significantly from each other inside and outside the cytoplasm 116, for example by more than 30%.

Coloring the cell nucleus 114 as well as the cytoplasm 116 and the cell background (to the left of line 110) is thereby performed by respectively selected preprocessing of the blood smear and can depend on the selected method.

For identifying the edge candidate pixels P_{N}, P_{O}, P_{S}, P_{W}, a change from a first section to a second section of the color space has been used, and this change corresponds to the significant decrease of the component F₂ at the dotted line 110. This means that the respectively selected method should be sensitive to a sudden decrease of the component F₂, but not at a sudden increase of the component F₂, as occurs, for example, at the nucleus boundary line 114.

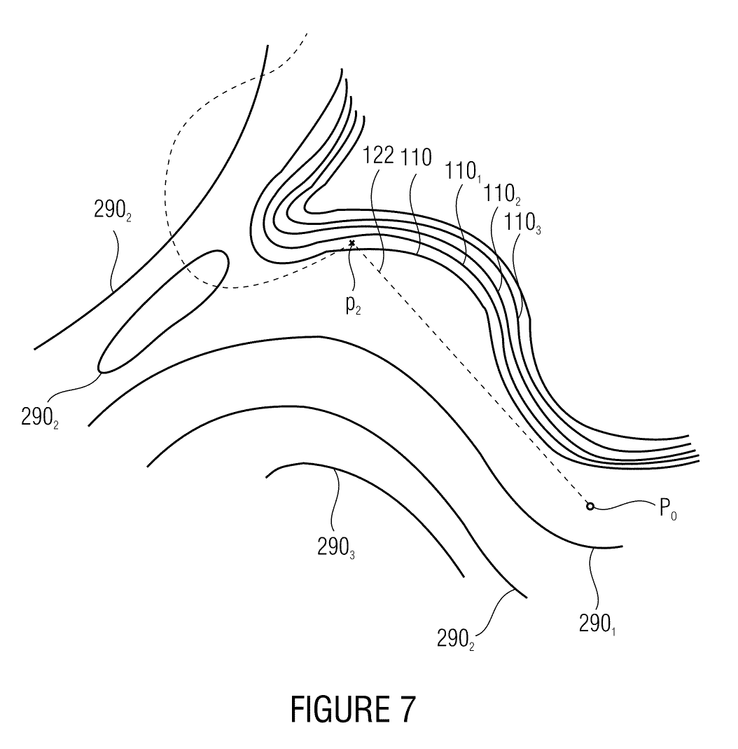

FIG. 7 shows a graphical illustration of the path-finding algorithm used for finding a connection between the edge candidate pixels P_{N}, P_{O}, P_{S}, P_{W}. The path-finding algorithm is based on a cost function, so that the preferred path is indicated by minimum costs. FIG. 7 shows a graphical illustration of such a cost function in the form of an elevation profile, wherein line 110 indicates the boundary of the cell contour and the path-finding algorithm provides the path 122. Thereby, the cost function is selected such that crossing the line 110 is punished, so that the result of the path-finding algorithm almost exclusively runs outside the line 110, i.e. outside the cell contour. This happens by a strong increase of the cost function from line 110 onwards, which is shown in an accumulation of elevation lines 110₁, 110₂, 110₃, . . . . On the other hand, the path 122 should not drift away too far from the cell contour line, so that an appropriately selected cost function also increases with increasing distance from the cell contour boundary line 110. This is given by the elevation lines 290₁, 290₂ and 290₃.

The path-finding algorithm determines the path 122 as far as possible “in the valley”, i.e. by avoiding the crossing of as few elevation lines as possible. On the other hand, along one elevation line or along a level with the same elevation line, the path is geometrically minimized and will thus run mostly as a straight line. This is the case for the path 122 from point P_{O} to point p₂, where the path 122 changes suddenly due to the crossing of the cell contour boundary line 110, so that the inside of the cell contour boundary line 110 is immediate left again. Subsequently, the path 122 is followed in a straight line, which continues in a wide arc to the cell contour 122 due to the slightly increasing cost function at the elevation line 290₂. This path-finding algorithm is continued until a closed path results which moves around the cell contour boundary line 110 apart from a few exceptions (as, for example, at point p₂).

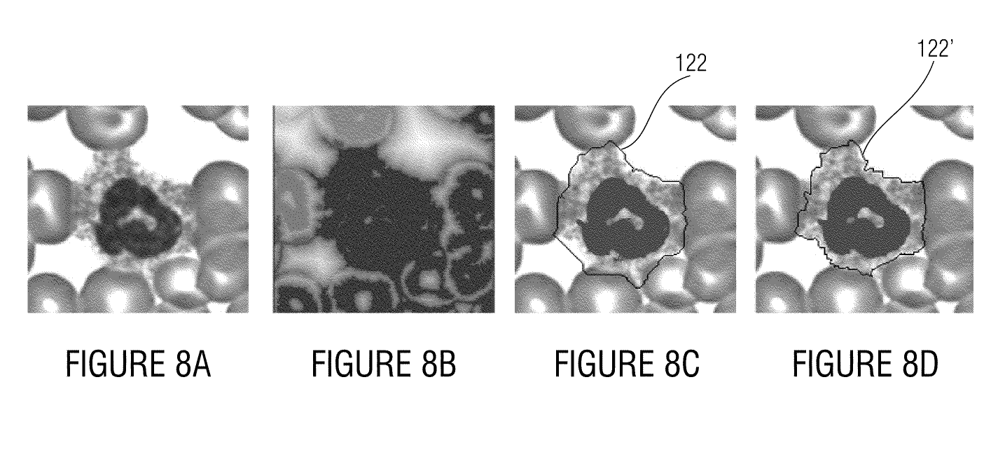

FIG. 8 shows four different images for four different stages during execution of the algorithm. FIG. 8a shows a starting image and FIG. 8b the cell contour distribution that has been obtained by a fast marching algorithm. In FIG. 8c, the path 122 is shown as the result of the path-finding algorithm prior to post-processing, and FIG. 8d shows a modified path 122′ as the result of post-processing (i.e. of a point-by-point shift towards the inside).

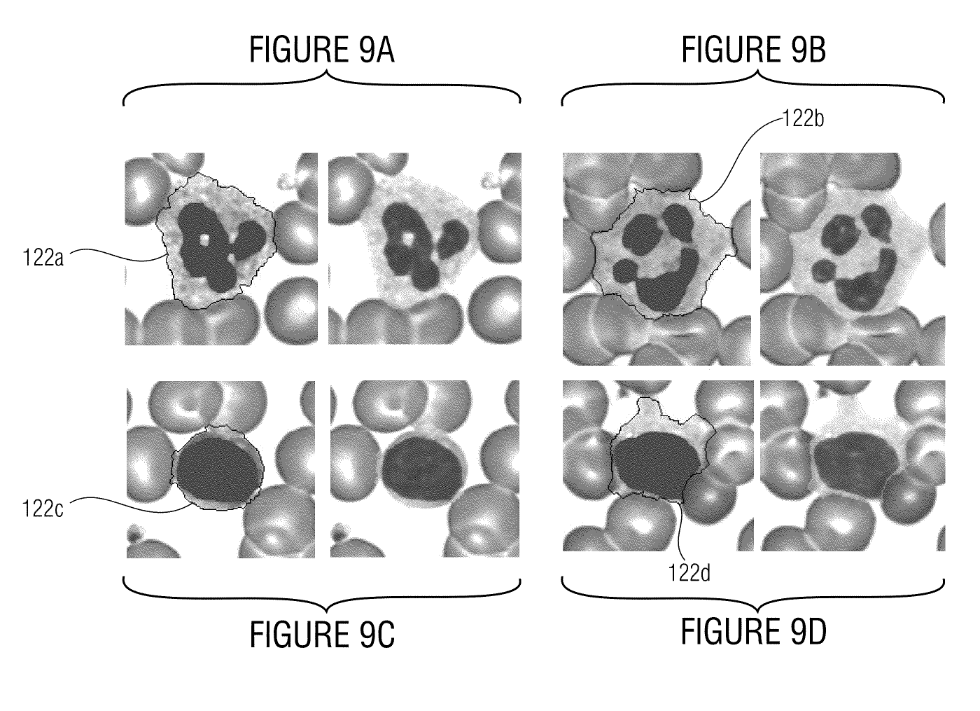

FIG. 9 illustrates four different types of leucocytes, wherein segmentation results of the cell nucleus 114 and the cytoplasm 116 are shown (by paths 122a, 122b, 122c, and 122d). FIG. 9b shows, for example, several cell nuclei, FIG. 9c shows an example for monocytes and FIG. 9a a cell nucleus 114 having a hole.

In summary, the inventive method can be described as follows. The segmentation of cell nucleus 114 and cytoplasm 116 of white blood cells is the basis for generating an automatic image-based differential blood count. In an inventive method for respective segmentation of leucocytes, first, preprocessing can be performed by a Kuwahara filter, and subsequently a fast marching method can be used for determining the rough cell contours. Subsequently, for obtaining the cell areas, a shortest path algorithm can be used. The marking of the cell nucleus 114 can be performed, for example, by a thresholding operation. An evaluation of the inventive method can be performed with the help of a representative sampling test, and can then be performed with segmentation by hand based on Dice coefficients as well the Hausdorff distance.

In particular it should be noted that, depending on the circumstances, the inventive scheme could also be implemented in software. The implementation can be performed on a digital memory medium, in particular a disc or a CD with electronically readable control signals that can cooperate with a programmable computer system such that the respective method is performed. Thus, generally, the invention also consists in a computer program product with a program code stored on a machine-readable carrier for performing the inventive method when the computer program product runs on a computer. In other words, the invention can be realized as a computer program with a program code for performing the method when the computer program runs on a computer.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1-21. (canceled)

22. A method for determining a cell contour of a cell comprising cell nucleus and cytoplasm in an image of the cell, comprising:
determining nucleus candidate pixels belonging to the cell nucleus;
determining a pixel inside the area formed by the nucleus candidate pixels for acquiring a central nucleus candidate pixel;
determining a first edge candidate pixel as a pixel on a predetermined path leading away from the central nucleus candidate pixel by detecting a change from a first section to a second section of a color space; and
finding edge candidate pixels leading away from the first edge candidate pixel, forming a boundary surrounding the cell, via a path-finding algorithm tending to prefer smaller path lengths and paths through pixels in the second section of the color space.

23. The method according to claim 22, wherein determining the nucleus candidate pixels comprises checking pixels as to whether the sum of their three color components in an RGB color space falls below a predetermined threshold.

24. The method according to claim 22, wherein the central nucleus candidate pixel is determined as a nucleus candidate pixel for which a sum of distances to the other nucleus candidate pixels becomes minimal.

25. The method according to claim 22, wherein further a second edge candidate pixel, a third edge candidate pixel and a fourth edge candidate pixel are determined on further predetermined paths leading away from the central nucleus candidate pixel in different directions by detecting a change from the first section to the second section of the color space.

26. The method according to claim 22, wherein the step of finding edge candidate pixels, which are leading away, via the path-finding algorithm is performed by using a cost function, wherein the cost function prefers moving away from the cell contour as compared to crossing the cell contour.

27. The method according to claim 22, wherein the path-finding algorithm uses a cost function, wherein the path-finding algorithm provides a straight path with a constant cost function.

28. The method according to claim 22, further comprising the step of transforming image data into an HSV color space.

29. The method according to claim 22, wherein, in the step of determining a first edge candidate pixel, an HSV color space comprising an H component, an S component and a V component is used as a color space, and wherein pixels of the cytoplasm are determined by crossing a predetermined boundary of the V component of the HSV color space.

30. The method according to claim 28, wherein the predetermined boundary γ is iteratively adapted, so that four edge candidate pixels are found on four different paths leading away from the central nucleus candidate pixel.

31. The method according to claim 22, further comprising preprocessing, and the preprocessing comprising usage of a Kuwahara filter.

32. The method according to claim 22, further comprising a step of classifying a cell nucleus, wherein segmenting a cell nucleus comprises using a ratio of a blue component to a green component of an RGB color space.

33. The method according to claim 22, further comprising post-processing, and the post-processing comprising point-by-point shifting of the path found by the path-finding algorithm.

34. The method according to claim 22, further comprising cell nucleus post-processing, and the cell nucleus post-processing comprising removing isolated nucleus candidate pixels.

35. The method according to claim 22, wherein the step of determining nucleus candidate pixels comprises determining pixels of the image within a first predetermined area of the color space.

36. An apparatus for determining a cell contour of a cell comprising a cell nucleus and a cytoplasm in an image of the cell, comprising:
a determiner for determining nucleus candidate pixels belonging to the cell nucleus;
a determiner for determining a pixel inside the area formed by the nucleus candidate pixels for acquiring a central nucleus candidate pixel;
a determiner for determining a first edge candidate pixel as a pixel on a predetermined path leading away from the central nucleus candidate pixel by detecting a change from a first section to a second section of a color space; and
a finder for finding edge candidate pixels leading away from the first edge candidate pixel, forming a boundary surrounding the cell, via a path-finding algorithm tending to prefer smaller path lengths and paths through pixels in the second section of the color space.

37. The apparatus according to claim 36, further comprising a Kuwahara filter.

38. The apparatus according to claim 36, further comprising an open-close filter.

39. The apparatus according to claim 36, further comprising a transformer for transforming from an RGB color space to an HSV color space.

40. The apparatus according to claim 36, further comprising a classifier for cell nucleus classification.

41. The apparatus according to claim 36, further comprising a post-processor for post-processing the cytoplasm, wherein post-processing comprises shifting a path determined by the path-finding algorithm.

42. A computer-readable medium having a computer program with program code for executing, when the computer program runs on a computer, a method for determining a cell contour of a cell having a cell nucleus and cytoplasm in an image of the cell, the method comprising:
determining nucleus candidate pixels belonging to the cell nucleus;
determining a pixel inside the area formed by the nucleus candidate pixels for acquiring a central nucleus candidate pixel;
determining a first edge candidate pixel as a pixel on a predetermined path leading away from the central nucleus candidate pixel by detecting a change from a first section to a second section of a color space; and
finding edge candidate pixels leading away from the first edge candidate pixel, forming a boundary surrounding the cell, via a path-finding algorithm tending to prefer smaller path lengths and paths through pixels in the second section of the color space.
